(19) United States
(12) Patent Application Publication
(10) Pub. No.: US 2014/0317286 A1
(43) Pub. Date: Oct. 23, 2014

(54) MONITORING COMPUTER AND METHOD

(71) Applicants: Mineyoshi Masuda, Tokyo (JP); Kiyomi Wada, Tokyo (JP)

(72) Inventors: Mineyoshi Masuda, Tokyo (JP); Kiyomi Wada, Tokyo (JP)

(73) Assignee: HITACHI, LTD., Tokyo (JP)

(21) Appl. No.: 14/358,745

(22) PCT Filed: Dec. 15, 2011
(86) PCT No.: PCT/JP2011/007014

§ 371 Date: May 16, 2014

(51) Int. Cl. G06F 11/34

(52) U.S. Cl. CPC G06F 11/34
USPC 709/224

(57) ABSTRACT

To achieve a balance between reduction of a disk capacity required to maintain measurement data and retention of necessary measurement data to analyze events. A monitoring computer stores measurement data about a monitoring target computer at a plurality of points in time in a storage device, specifies an event, which has occurred at the monitoring target computer, and event occurrence time based on the measurement data, and selects part of the measurement data at the plurality of points in time as a deletion target in consideration of the measurement data which should not be deleted, based on a capacity of the storage device or a predetermined retention period of the measurement data, and a deletion exception period calculated from the event occurrence time.

### TECHNICAL FIELD

The present invention relates to a technique to delete measurement data obtained as a result of monitoring with a device for monitoring the status and performance of a computer system.

### BACKGROUND ART

A monitoring system performs monitoring to check if an information system with proper performance processes information. The monitoring system collects performance information from components (such as computers, an operating system, and applications) that constitute a monitoring target computer system. The monitoring system analyzes the collected performance information and judges whether the performance of the information system is proper or not.

A data amount of the performance information collected by the monitoring system becomes enormous. This is because the monitoring target computer system is composed of a large number of components and a time interval for collection of the performance information from the monitoring target system is short, that is, in the order of minutes. With a monitoring system that monitors a large-scale computer system composed of more than 1,000 computers, the data amount of performance information per day sometimes reaches dozens of giga bytes.

Patent Literature 1 discloses a technique that dynamically changes a monitoring interval for a monitoring system and divides measurement periods into periods, during which measurement is performed at a short interval, and periods during which measurement is performed at a long interval. Specifically speaking, Patent Literature 1 discloses that monitoring at normal time is performed at a long monitoring interval and the monitoring interval is shortened under a specific condition, for example, after the occurrence of a performance failure.

### CITATION LIST

### Patent Literature

[Patent Literature 1] Japanese Patent Application Laid-Open (Kokai) Publication No. 5-205074

### SUMMARY OF INVENTION

### Problems to be Solved by the Invention

The aforementioned conventional monitoring method can keep detailed data only after the occurrence of an anomaly of the monitoring target system. However, detailed data before the occurrence of the anomaly cannot be kept.

The present invention was devised in consideration of the above circumstances and it is an object of the invention to keep minimum detailed data without deleting them and respond to a detailed data reference request by an administrator.

### Means for Solving the Problems

According to the present invention, the administrator specifies a period of detailed data, regarding which there is a high possibility that reference will be made to the detailed data at a later date, and then deletes other detailed data.

According to a first embodiment of the present invention, there is considered to be a high possibility that during a period of time immediately before and after the occurrence of an event in the system (event) (hereinafter referred to as the adjacent period) reference will be made to the relevant detailed data at a later date; and the detailed data during a specified period of time before and after the event (hereinafter referred to as the protection period) will be kept. Furthermore, the protection period is prioritized according to importance of events; and even if the detailed data are during the protection period, the detailed data are deleted from the lowest priority in the order of ascending priority.

In a first embodiment, a predefined period is set as a protection period; however, in a second embodiment, the protection period is not a specified value and a period of time until the system gets out of an abnormal state after the occurrence of an event and returns to a normal state is defined as the protection period. Specifically speaking, the length of the protection period is changed depending on the status of the system. As a result, the length of the protection period can be optimized.

Furthermore, according to a third embodiment of the present invention, the length of the protection period is decided based on a history of reference made by the administrator to the detailed data. As a result, the length of the protection period can be further optimized.

### Advantageous Effects of Invention

According to the present invention, it is possible to keep only as small an amount of detailed data as possible, for which there is a high possibility that the administrator will refer to the detailed data at a later date.

### BRIEF DESCRIPTION OF DRAWINGS

FIG. 1 is a block diagram showing a schematic configuration of the entire system according to a first embodiment.

FIG. 2 is a conceptual diagram showing a data structure of storage resources.

FIG. 3 is a conceptual diagram showing the structure of a detailed data table.

FIG. 4 is a conceptual diagram showing the structure of a summary data table.

FIG. 5 is a conceptual diagram showing the structure of an event table.

FIG. 6 is a conceptual diagram showing the structure of a setting table.

FIG. 7 is a conceptual diagram showing the structure of a protection period table.

FIG. 8 is a conceptual diagram showing the structure of a baseline table.

FIG. 9 is a conceptual diagram showing the structure of a data reference recording table.

FIG. 10 is a conceptual diagram showing the structure of a quota table.

FIG. 11 is a flowchart illustrating a processing sequence for entry creation processing.

FIG. 12 is a flowchart illustrating a processing sequence for first detailed data deletion processing.

FIG. 13 is a flowchart illustrating a processing sequence for protection period acquisition processing.

FIG. 14 is a flowchart illustrating a processing sequence for processing for recording time when a user refers to detailed data.

FIG. 15 is a flowchart illustrating a processing sequence for second detailed data deletion processing.

FIG. 16 is a flowchart illustrating a processing sequence for period setting processing.

FIG. 17 is a plan view showing a screen structure example of a performance information screen for displaying performance information to the administrator.

### MODE FOR CARRYING OUT THE INVENTION

An embodiment of the present invention will be explained below in detail with reference to drawings.

### (1) First Embodiment

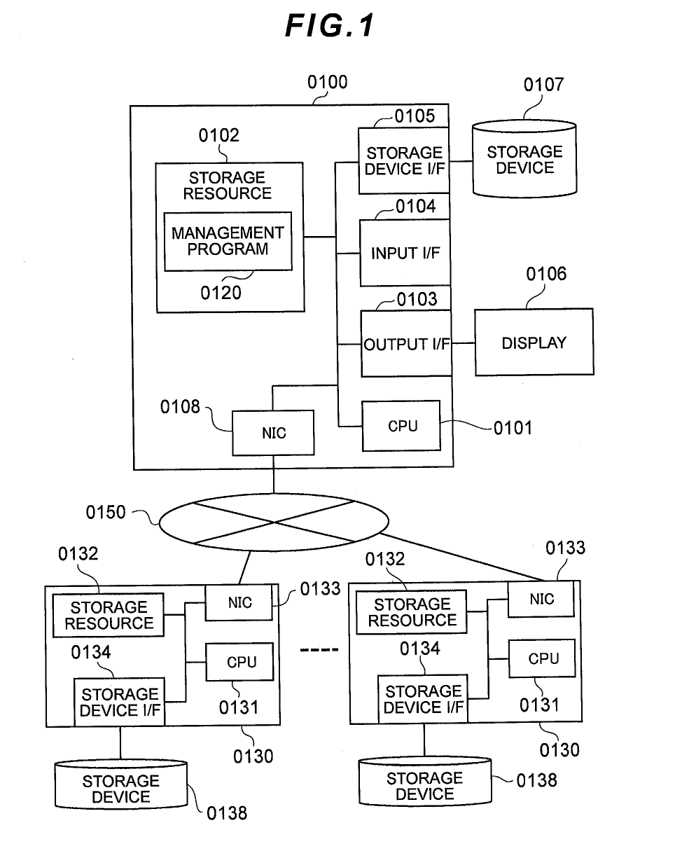

FIG. 1 is a configuration diagram of the entire system according to a first embodiment. The management computer 0100 is a physical computer and includes a CPU 0101, a storage resource 0102, an output interface (an interface will be hereinafter referred to as an I/F) 0103, an input I/F 0104, a storage device I/F 0105, and a network interface card (hereinafter referred to as the NIC) 0108. The input I/F 0104 of the management computer 0100 is connected to input devices such as a mouse and a keyboard and accepts operations by the user. The output I/F 0103 is connected to an output device such as a display 0106 and outputs screens to the user. Other devices such as a printer (not shown in the drawing) can be connected to the output I/F 0103 as long as they are output devices. The NIC 0108 is connected via a network 0150 to a monitoring target computer 0130.

The monitoring target computer 0130 is a computer having the same hardware configuration as that of the management computer 0100 and each monitoring target computer 0130 is configured by including a CPU 0131, a storage resource 0132, an NIC 0133 for network connection with the management computer 0100, and a storage device I/F 0134 for connection with each storage device 0138. Other components such as the input I/F 0104 and the output I/F 0103, which are mounted in the management computer 0100 may be provided in the monitoring target computer 0130 although they are not illustrated in the drawing.

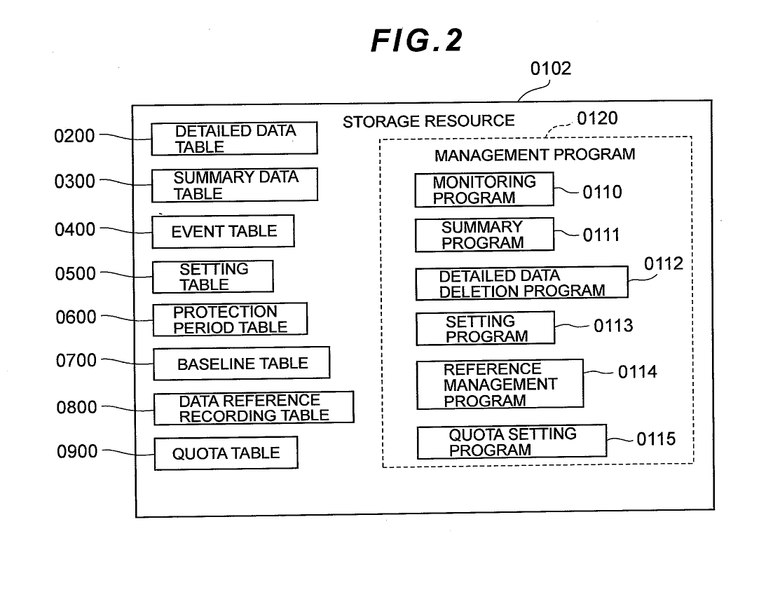

FIG. 2 shows a data configuration of the storage resource 0102. The storage resource 0102 stores a management program 0120 and various tables (explained later). The management program 0120 includes a monitoring program 0110, a summary program 0111, a detailed data deletion program 0112, a setting program 0113, a reference management program 0114, and a quota setting program 0115. These programs are normally stored in the storage device 0107 and is loaded to and mounted in the storage resource upon request of the CPU 0101. Incidentally, the storage device 0107 may be the same as or different from the storage resource 0102.

Tables stored in the storage resource 0102 are, for example: a detailed data table 0200 in which the monitoring program 0110 stores the results of monitoring the monitoring target computer 0130; a summary data table 0300 that stores summary data created by the summary program 0111 based on the content of the detailed data table 0200; an event table 0400 that stores event information detected by the monitoring program 0110; a setting table 0500 that stores the content of settings by the administrator; a protection period table 0600 for managing a protection period of detailed data which are preserved for a long period of time (or protected without being deleted); a baseline table 0700 that stores baseline data created by the monitoring program 0110 based on the content of the detailed data table 0200; a data reference recording table 0800 that stores a history of reference made by the administrator to the detailed data table 0200; and a quota table 1000 that stores quota settings. Each program reads or writes information from or to these tables in accordance with the processing as appropriate. These tables are also stored in the storage device 0107; and the CPU 0101 reads the tables from the storage device 0107 and loads them to the storage resource 0102 or stores information of the various tables, which are in the storage resource 0102, in the storage device 0107 as the need arises.

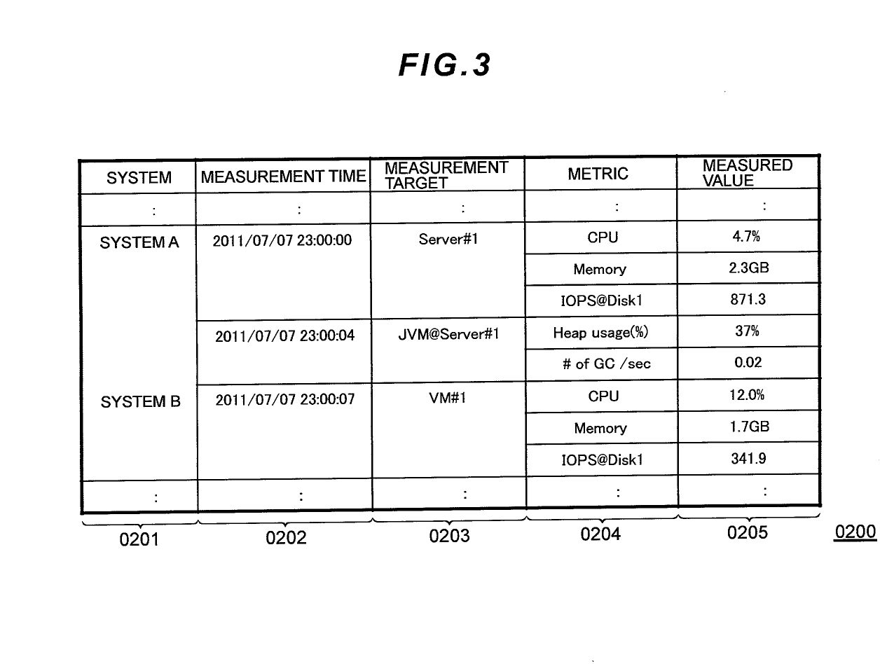

FIG. 3 shows the structure of the detailed data table 0200. This detailed data table 0200 stores performance information acquired by the monitoring program 0110 from an OS, applications, and a monitoring agent program which operate on the monitoring target computer 0130. The monitoring program 0110 acquires the performance information from the OS, applications, and monitoring agent program, which operate on the monitoring target computer 0130, periodically or upon request of the administrator and stores the acquired performance information in the detailed data table 0200. The detailed data table 0200 is constituted from: a system column 0201 that stores information indicating a system to which the monitoring target computer 0130 belongs; a measurement time column 0202 that stores time when the performance information was recorded; a measurement target column 0203 that stores information indicating a target whose performance was measured; a metric column 0204 that stores a metric indicating a measured monitored item; and a measured value column 0205 that stores a measured value.

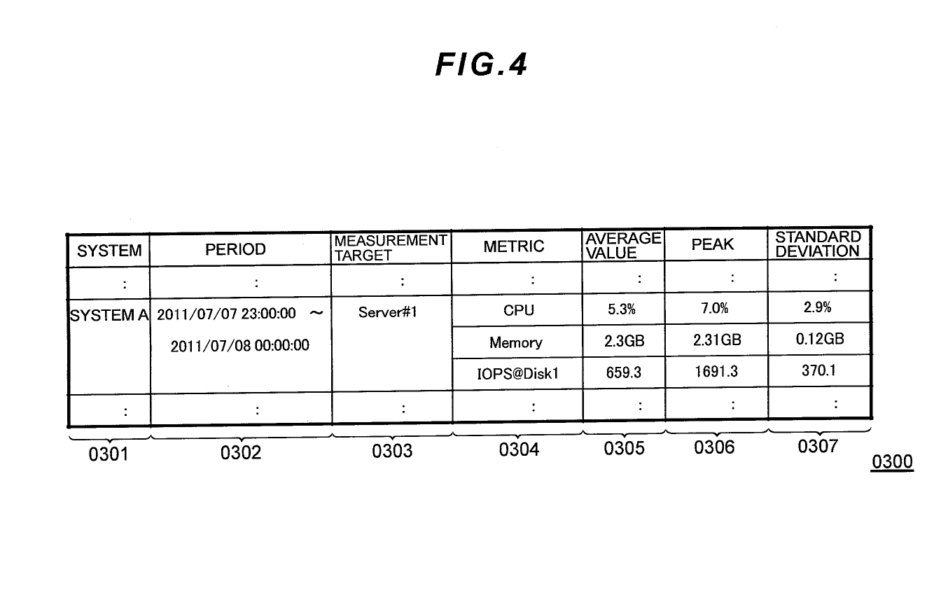

FIG. 4 shows the structure of the summary data table 0300. This summary data table 0300 stores the results of summary processing executed by the summary program 0111 on the data stored in the detailed data table 0200. The summary processing herein means to divide the measurement data stored in the detailed data table 0200 by a certain period of time (for example, by one hour) and execute statistic processing on the measurement data belonging to each period.

A system column 0301, a measurement target column 0303, and a metric column 0304 of the summary data table 0300 store the same information as that stored in the system column 0201, the measurement target column 0203, and the metric column 0204 of the detailed data table 0200, respectively, which are the basis of the statistic processing. The period column 0302 stores a target period of the summary processing. An average value column 0305, a peak column 0306, and a standard deviation column 0307 store statistic values (an average value, a peak value, or a standard deviation) obtained respectively as the result of the summary processing. Incidentally, the summary data table 0300 may store statistic values other than these statistic values.

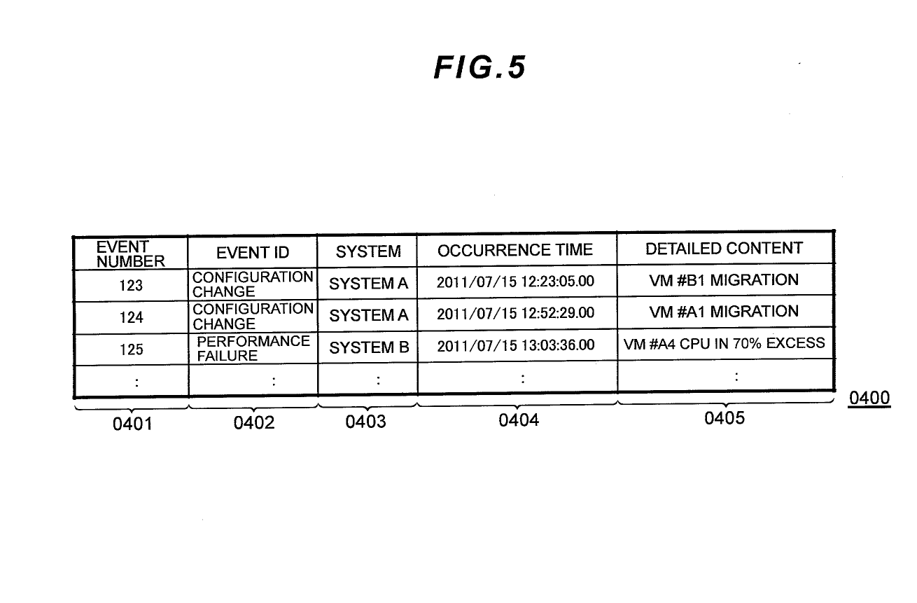

FIG. 5 shows the structure of the event table 0400. The monitoring program 0110 checks whether each piece of measurement data acquired from the monitoring target computer 0130 meets a specified condition or not; and if the measurement data meets the specified condition, the monitoring program 0110 stores the relevant content and occurrence time in the event table 0400.

The event table 0400 is constituted from: an event number column 0401 storing an event number that is a serial number of an event which has occurred; an event ID column 0402 that stores an event ID indicating the type of the event which has occurred; a system column 0403 that stores system information indicating a system where the event has occurred; an occurrence time column 0404 that stores occurrence time of the event; and a detailed content column 0405 storing the detailed content of the event which has occurred. Incidentally, this embodiment is designed so that an event that meets the specified condition is detected based on data stored in the detailed data table 0200; however, data that is not be used to detect the event may be stored in the detailed data table 0200.

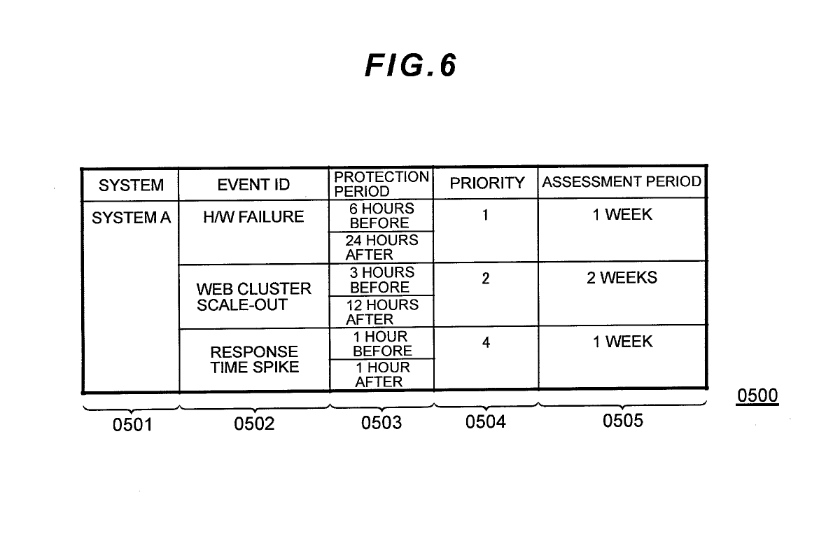

FIG. 6 shows the structure of the setting table 0500. This setting table 0500 stores the content of various settings which are the basis for deciding a period of time for which the management computer 0100 keep the detailed data. Specifically speaking, the setting table 0500 stores information about a protection period (how long before and after the event the detailed data should be kept). The protection period is set for each system or for each event type. The setting program 0113 accepts input of the settings from the administrator and stores the content in the setting table 0500.

The setting table 0500 is constituted from: a system column 0501 that stores information indicating a setting target system; an event ID column 0502 that stores an event ID indicating a setting target event type; a protection period column 0503 that stores a protection period indicating an adjacent period before and after event occurrence time; and a priority column 0504 that stores priority indicating how difficult to delete the detailed data. Furthermore, the setting table 0500 is provided with an assessment period column 0505 that stores an assessment period. The assessment period is a period of time, during which there is a high possibility that the administrator may refer to the detailed data before and after the relevant event. In other words, after the elapse of the assessment period after the occurrence of the event, the possibility of reference made to the detailed data before and after the occurrence of the event reduces.

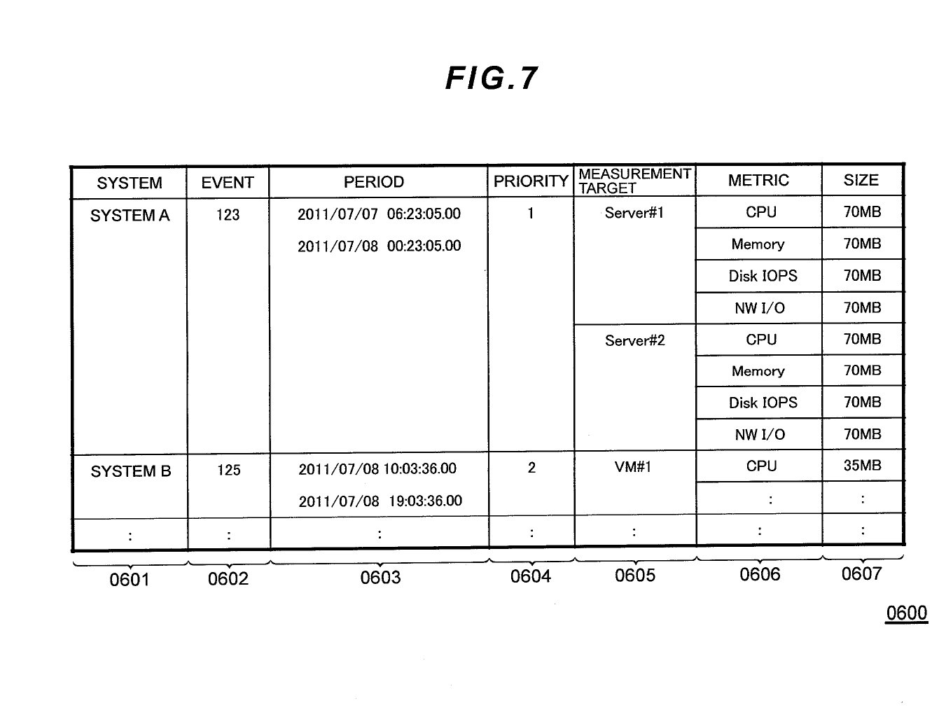

FIG. 7 shows the structure of the protection period table 0600. The protection period table 0600 is constituted from: a period column 0603 that stores a period of time during which the detailed data about the monitoring target computer system should preferably be kept; a priority column 0604 that stores priority of the detailed data; an event column 0602 that stores an event serial number of an event which caused the detailed data to be kept; a measurement target column 0605 that stores information indicating a measurement target; a metric column 0606 that stores information indicating a metric which is an object within the measurement target; and a size column 0607 that stores the size of the detailed data about the relevant metric.

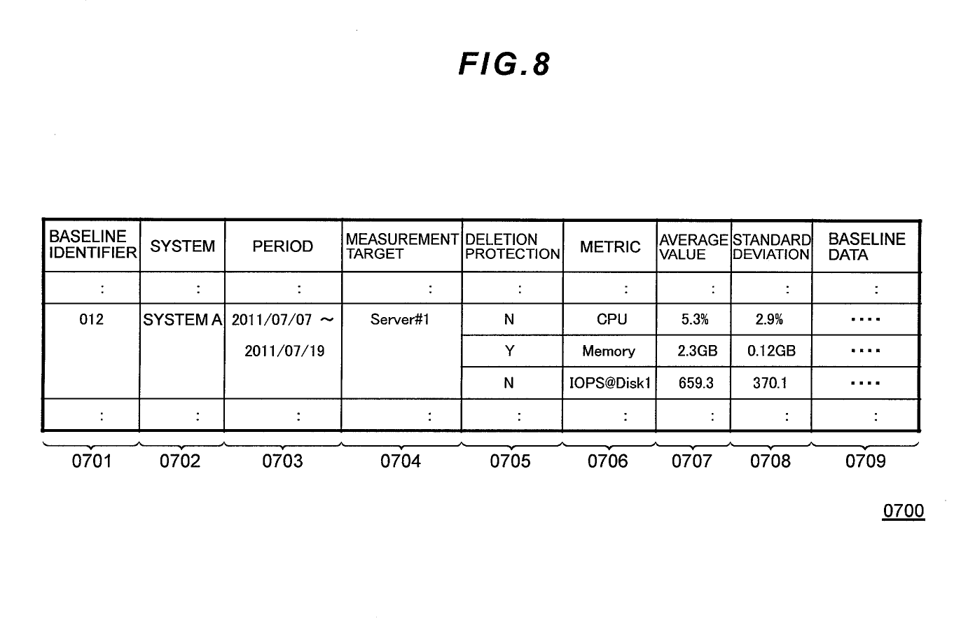

FIG. 8 shows the structure of the baseline table 0700. This baseline table 0700 stores a baseline of each metric in the monitoring target computer system. The baseline is a normally assumed baseline of the relevant metric. The baseline is calculated as a statistic value of the measurement data of the same day and the same hours of the day.

The baseline table 0700 is constituted from: a baseline identifier column 0701 that stores a baseline identify for identifying an individual baseline; a system column 0702 that stores information indicating a target system of the created baseline; a period column 0703 that stores a data collection period based on which the baseline was created; a measurement target column 0704 that stores information indicating a measurement target; a metric column 0706 that stores information indicating a target metric; and a baseline data column 0709 that stores baseline data (statistic values such as an average value and a standard deviation) about the relevant metric.

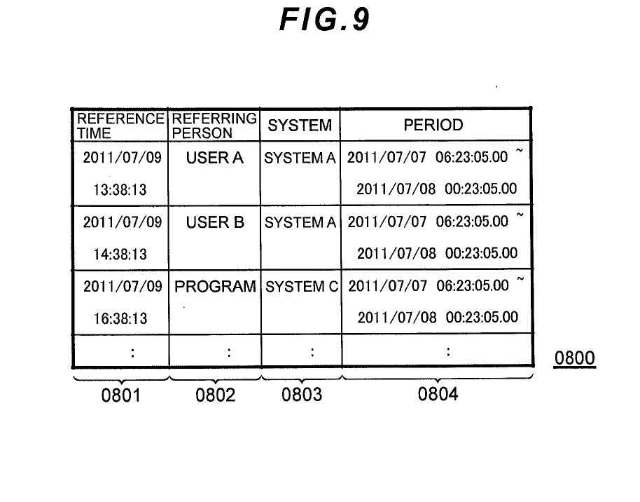

FIG. 9 shows the structure of the data reference recording table 0800. This data reference recording table 0800 stores information indicating when and who referred to the detailed data of which system and which period. Specifically speaking, the data reference recording table 0800 is constituted from: a reference time column 0801 that stores time when reference was made to the relevant detailed data (reference time); a referring person column 0802 that stores information indicating a referring person who referred to the detailed data; a system column 0803 that stores information indicating a reference target system; and a period column 0804 indicating a period of time which is a reference target of the detailed data.

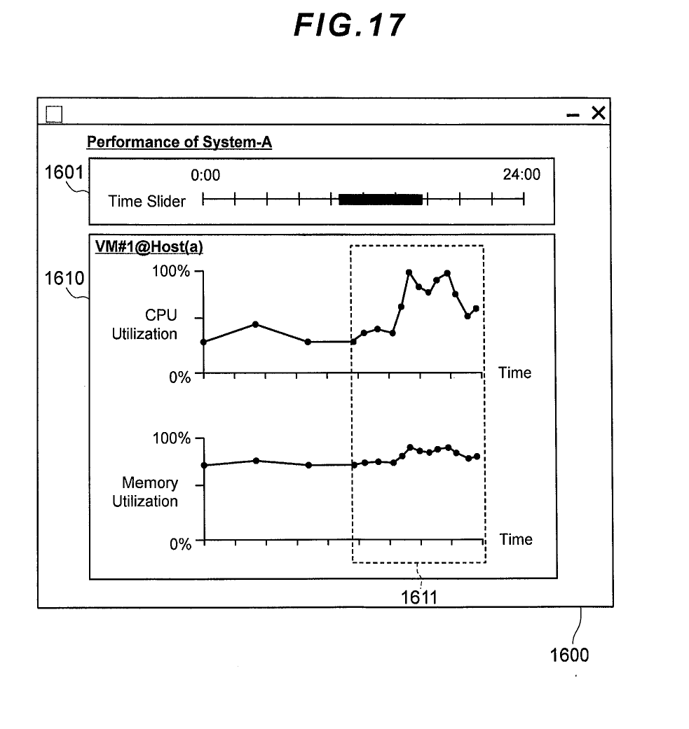

Data are stored in the data reference recording table 0800 by the reference management program 0114. The reference management program 0114 accepts a system performance information reference request from the administrator, acquires the requested performance information from the detailed data table 0200 or the summary data table 0300, and displays a performance information screen 1600 on the display 0106. A screen structure example of the performance information screen 1600 is shown in FIG. 17.

The performance information screen 1600 displays: a performance graph 1610 that displays performance information such as a CPU activity ratio and memory usage of, for example, servers and virtual machines (VM: Virtual Machines) constituting the system for which a display request is issued; and a display time period 1601 indicating a time period during which this screen is displayed. The detailed data and the summary data are also displayed together with the performance graph 1610. Specifically speaking, if the performance information of the time period for which the display request was made remains in the detailed data table 0200 without being deleted, a detailed performance graph as indicated in a broken line frame in FIG. 17 (a performance graph 1611 based on the detailed data) will be displayed; and if the detailed data is deleted, a rough performance graph based on the summary data will be displayed.

The administrator can change the time period for displaying the performance information by operating the display time period 1601 (for example, by moving a slider for the display time period 1601 shown in FIG. 17 to the right and left). The reference management program 0114 acquires the performance information, which should be newly displayed, from the detailed data table 0200 or the summary data table 0300 in accordance with the change of the time period to be displayed and then updates the performance graph 1610. At that time, the reference management program 0114 stores the time period, to which reference was made, in the data reference recording table 0800.

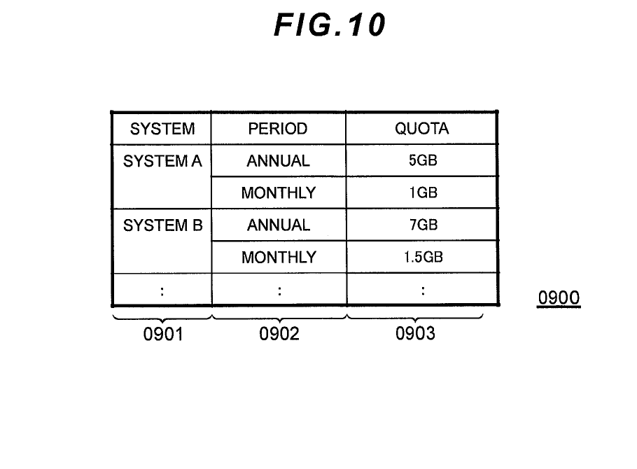

FIG. 10 shows the structure of the quota table 0900. The quota table 0900 stores an upper limit of a data size of the detailed data for each system (hereinafter referred to as the quota). The quota may be decided for each period, for example, as less than 1 GM for each month or less than 5 GB through a full year. FIG. 10 is a structure example for the quota table 0900 in a case where the quota is decided for each period as mentioned above. This quota table 0900 is constituted from a system column 0901 that stores information indicating the relevant system; and a quota column 0903 that stores a quota defined for that period.

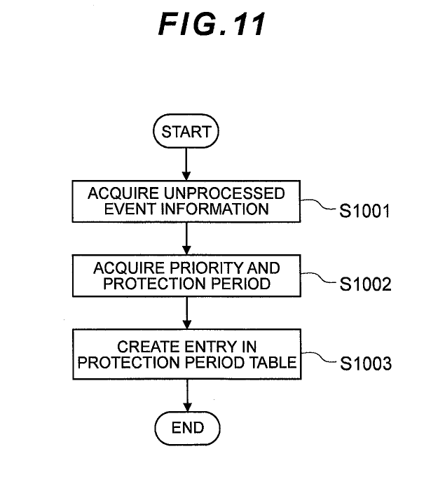

FIG. 11 shows a processing sequence for processing executed by the monitoring program 0110 when creating an entry in the protection period table 0600 (hereinafter referred to as the entry creation processing). The monitoring program 0110 registers an event in the event table 0400 as mentioned above. The monitoring program 0110 creates an entry in the protection period table 0600 in accordance with settings stored in the setting table 0500 with respect to each registered event.

(S1001) The monitoring program 0110 acquires an unprocessed event (an event for which an entry corresponding to the event has not been created in the protection period table 0600) from the event table 0400.
(S1002) The monitoring program 0110 acquires information about an entry, whose event ID of the unprocessed event matches, from the setting table 0500. This information includes priority and a protection period (a period before and after the event) corresponding to the relevant event, which are stored in the priority column 0504 and the protection period column 0503 of the setting table 0500.
(S1003) The monitoring program 0110 creates an entry in the protection period table 0600 based on the priority and the protection period, which were acquired in the previous step, and information about the event itself. The period column 0603 of the entry to be created stores the protection period which was acquired in step S1002 and starts at the occurrence time of the event. Also, the priority column 0604 of the entry to be created stores the priority acquired in the previous step.

Incidentally, such entry creation processing may be executed every time an event is detected, or may be executed periodically and executed on a plurality of events collectively which have been detected after the execution of the processing last time.

Next, the first detailed data deletion processing executed by the detailed data deletion program 0112 will be explained.

The detailed data deletion program 0112 sets an assessment period of the relevant system. The assessment period is a period of time between the following points in time (time (A) and time (B)):

(A) current time; and
(B) occurrence time of an event which occurred most often in the past among events during the assessment period.

Events during the assessment period are events regarding which the elapsed time after the occurrence of the relevant event is within the assessment period stored in the assessment period column 0505 of the setting table 0500.

If there is no event during the assessment period, the detailed data deletion program 0112 sets a given period (for example, one week) as the assessment period.

(S1101) The detailed data deletion program 0112 acquires all events which occurred at the relevant system, by referring to the event table 0400. Next, the detailed data deletion program 0112 refers to the corresponding assessment period column 0505 of the setting table 0500 based on the event IDs of these events stored in each event ID column 0402 and acquires the assessment period for each event.
(S1102) The detailed data deletion program 0112 finds an unprotected period of the relevant system. The unprotected period is a period during which the detailed data is not protected against the deletion processing; and specifically speaking, the unprotected period is a period of time which is neither the assessment period nor the protection period. The detailed data deletion program 0112 refers to the protection period table 0600 and acquires a list of protection periods for the relevant system. The detailed data deletion program 0112 sets a period of time excluding these protection periods and the assessment period found in S1101 as the unprotected period.
(S1103) The detailed data deletion program 0112 deletes the detailed data of the unprotected period from the detailed data table 0200.
(S1104) The detailed data deletion program 0112 checks if the data amount after deleting the detailed data exceeds the quota stored in the quota table 0900 or not. In a case of a quota violation, the detailed data deletion program 0112 proceeds to step S1105; and if it is not a quota violation, the detailed data deletion program 0112 terminates the processing.

The detailed data deletion program 0112 deletes the detailed data of the protection period(s) until the quota violation is resolved in step S1105 and step S1106.

(S1105) The detailed data deletion program 0112 ranks the protection periods in order to decide the protection period for the deletion target. Specifically speaking, the detailed data deletion program 0112 refers to the protection period table 0600 and acquires and ranks the protection periods for the relevant system. The protection periods are ranked by, for example, firstly sorting them according to the priority stored in the priority column 0604 and then sorting events of the same priority in the order of the occurrence time. In order words, the protection period for an old event with lower priority tends to be deleted more easily.
(S1106) The detailed data deletion program 0112 deletes the protection periods sorted in step S1105 in the ascending order from the lowest priority until the data amount satisfies the quota. The detailed data deletion program 0112 deletes the information in the detailed data table 0200 and also deletes the relevant protection periods in the protection period table 0600 at the same time.

The periods of the detailed data to which the administrator will refer at a later date seem to have the following characteristics (A) to (D):

(A) a period of time before and after the occurrence of an event such as a performance failure or a configuration change at the information processing system has higher reference possibility than that of other periods;
(B) the more significant the event is, the higher the reference possibility becomes;
(C) the shorter the elapsed time after the occurrence of the event is, the higher the reference possibility becomes; and
(D) when the event occurrence time is considered to be center time, the closer to the center time the relevant period is, the higher the reference possibility becomes.

The management computer 0100 according to this embodiment keeps the detailed data for the period of time, which falls under the above-described characteristics, and deletes other detailed data. As a result, it is possible to keep the detailed data, to which the administrator may highly possibly refer to, and delete the data amount of the detailed data.

### (2) Second Embodiment

In this embodiment, the length of a protection period for detailed data is not a fixed length stored in the setting table 0500, but is dynamically changed according to a measured value of the relevant system. As a result, data to be stored can be further limited to a necessary amount.

Specifically speaking, the protection period for the detailed data is set as a period of time from the occurrence of an event at the system to the time of recovery of the system to its normal state. In other words, a period of time from the state where any anomaly is found in the system, until the recovery of the system to the state no different from its normal state is defined as the protection period for the detailed data.

A baseline is used to judge whether the system is in a normal state or not. Specifically speaking, a value width indicated by a measured value of the system in its normal state is calculated from a history of the measured value of the system. For example, an average value and a standard deviation (indicating its variability of how much width) are calculated from a history of the CPU activity ratio of the system. Also, an average and a standard deviation for each time period of the system are calculated from the history for one week. The width of the average value plus/minus the standard deviation is a range of the measured value of the system in its normal state. Whether the system is in the normal state or not can be judged based on whether the measured value is within this range or not.

There is one note of caution about the judgment of normality based on the baseline. The baseline is created from the history of the measured value of the system. This is based on the premise that behaviors of the system have not changed. However, after the configuration of the system is changed, there is a possibility that the behaviors of the system might have changed. So, the above-mentioned premise is no longer true. Therefore, after the configuration of the system is changed, it is necessary to reset the baseline based on data measured after the configuration change.

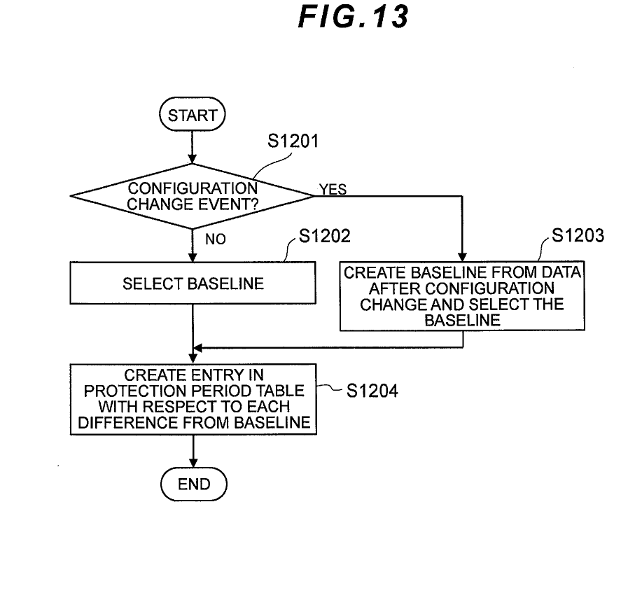

FIG. 13 illustrates a processing sequence for protection period acquisition processing executed by a management computer according to the second embodiment instead of step S1002 during the aforementioned entry creation processing with reference to FIG. 11. In the first embodiment, the detailed data deletion program 0112 refers to the setting table 0500 and reads the fixed protection period in step S1002. The protection period acquisition processing shown in FIG. 13 is processing for finding a latter half of a protection period (from the event occurrence time to the end of the protection period).

(S1201) The detailed data deletion program 0112 judges whether the type of the event is a configuration change event or not. This judgment can be performed by referring to the event ID 0402 of the event table 0400. If the event is the configuration change event, the detailed data deletion program 0112 proceeds to step S1203; and if the event is not the configuration change event, the detailed data deletion program 0112 proceeds to step S1202.
(S1202) If the event is not the configuration change, the detailed data deletion program 0112 refers to the baseline table 0700 and acquires the baseline for the relevant system. The acquired baseline may be created based on measured values before the occurrence of the event. However, if the event is the configuration change event, the detailed data deletion program 0112 acquires the baseline created from data measured after the configuration change.

Next, the detailed data deletion program 0112 reads the measured values of the system after the occurrence of the event little by little from the detailed data table 0200 and compares them with the baseline. If differences between the measured values and the baseline are within a normal range, the detailed data deletion program 0112 recognizes that the system has recovered to its normal state, and then sets a period of time until that time as its corresponding protection period for the detailed data.

A period of time during which the administrator will refer to the detailed data at a later date seems to have the following characteristic (A) in addition to the characteristics mentioned in the first embodiment: (A) the possibility for the administrator to refer to the detailed data during a period of time when the information processing system is in a normal state is low. Even if the administrator refers to the detailed data during this period, they can observe only the state that is no different from the normal state of the information processing system, and can learn little from that observation. In other words, there is a high possibility that the administrator will refer to the detailed data during a period of time when the information processing system indicates some sort of an abnormal state.

In this embodiment, the period of time from the occurrence of some sort of anomaly in the information processing system (that is, the event occurrence time) to the time when the information processing system recovers to its normal state is kept as a period with a high possibility for the administrator to refer to the detailed data; and a period of time after the recovery to the normal state is deleted as a period of time with a low possibility for the administrator to refer to the detailed data. As a result, it is possible to enhance the possibility to keep the detailed data, to which the administrator will refer, than the performance monitoring device according to the first embodiment in which the detailed data is kept for only the fixed period of time before and after the occurrence of the event.

### (3) Third Embodiment

In this embodiment, the lengths of the assessment period and the protection period are changed based on a history of data reference by the user.

The reference management program 0114 reads data of a specified time period from the detailed data table 0200 or the summary data table 0300 and displays them in a format such as a graph on the display 0106 via the output I/F 0103. The user analyzes a performance failure with reference to the displayed graph by scrolling the time period for the data to be displayed. The user's operation to, for example, scroll the graph is transmitted via the input I/F 0104 to the reference management program 0114.

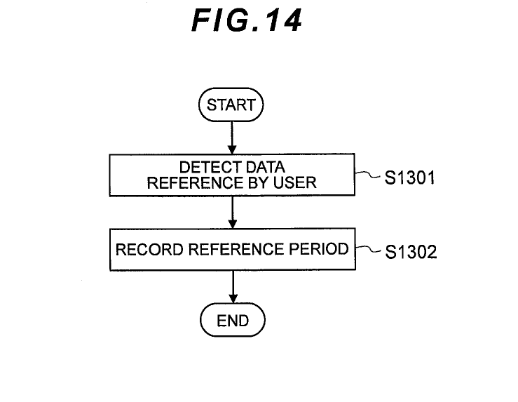

The reference management program 0114 records the transmitted reference time period, during which reference was made by the user, in the data reference recording table 0800. That processing sequence is illustrated in FIG. 14.

(S1301) The reference management program 0114 firstly receives the data reference by the user and the time period, during which reference was made by the user, from the input I/F.
(S1302) Next, the reference management program 0114 records information such as the reference time period in the data reference recording table 0800.

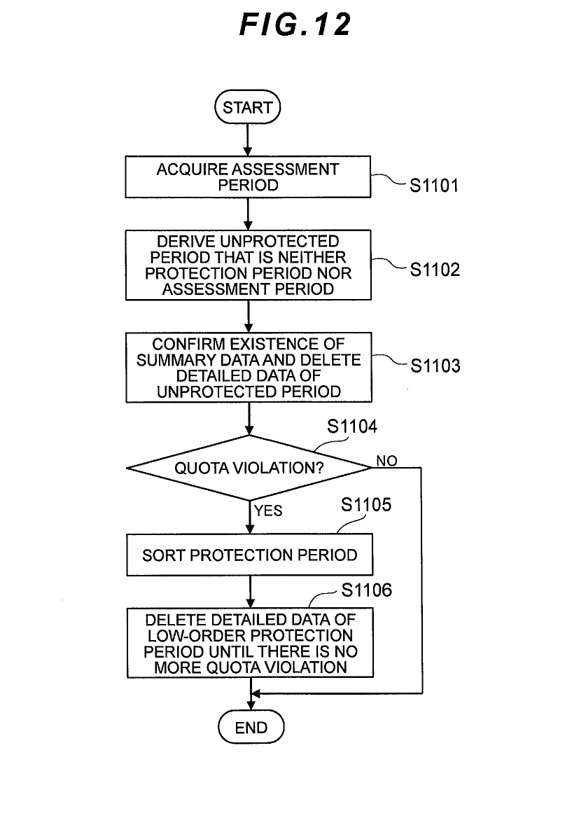

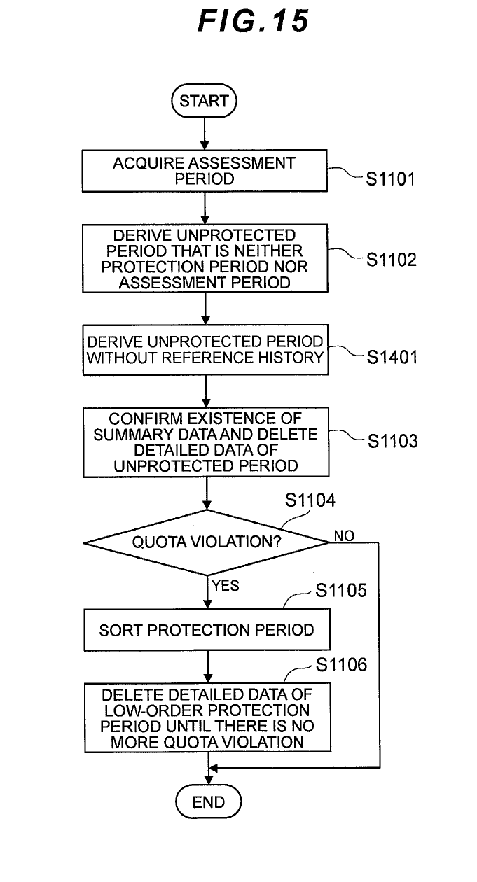

FIG. 15 illustrates a processing sequence for the second detailed data deletion processing executed by the detailed data deletion program 0112 for deleting the detailed data in this embodiment. The processing sequence for the second detailed data deletion processing as illustrated in FIG. 15 is almost the same as the processing sequence for the first detailed data deletion processing as illustrated in FIG. 12 and the difference between them is that step S1401 is added to between step S1102 and step S1103 in the second detailed data deletion processing.

(S1401) This processing is processing for excluding a period of time, which is recorded as being referred to by the user, from the deletion target even if that period is an unprotected period. The detailed data deletion program 0112 excludes a period of time, which overlaps with the recorded reference time period stored in the data reference recording table 0800, among the unprotected periods found in step S1102, from the unprotected periods.

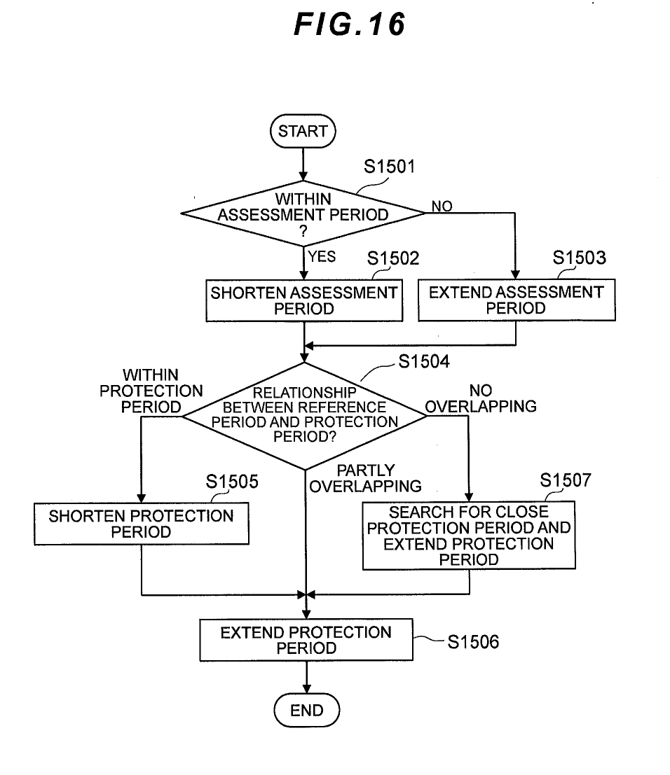

In this embodiment, the assessment period and the protection period are set based on the records of data reference by the user. FIG. 16 illustrates a processing sequence for period setting processing executed by the setting program 0113 for setting the assessment period and the protection period.

The setting program 0113 judges whether the user refers to an event, which has occurred in the system, during the assessment period or not. If the user refers to the event during the assessment period, it means that a current set value of the assessment period is correct (or the assessment period is longer than necessary); and if the user refers to the event after the assessment period, it means that the current set value of the assessment period is too short.

(S1501) The setting program 0113 acquires the event occurrence time of the system which is stored in the occurrence time column 0404 of the event table 0400; and examines if the user referred to the event when the elapsed time after the relevant occurrence time is within the assessment period of the event which is stored in the assessment period column 0505 of the setting table 0500. This examination is performed by judging whether the reference time stored in the reference time column 0801 of the data reference recording table 0800 is within the assessment period of the event or not. If the user's reference time is within the assessment period, the setting program 0113 proceeds to step S1502; and if the user's reference time is not within the assessment period, the setting program 0113 proceeds to step S1503.
(S1502) The setting program 0113 shortens the assessment period of the relevant event. A shortening method may be to shorten the currently set assessment period by certain minutes or setting an assessment period which covers 90% (the number is arbitrary) of all the events.
(S1503) On the other hand, the setting program 0113 extends the assessment period of the relevant event. An extension method may be, like the shortening method, to extend the currently set assessment period by certain minutes or setting an assessment period which covers 90% (the number is arbitrary) of all the events.

Subsequently, the setting program 0113 judges the adequacy of the length of the corresponding protection period for the detailed data and changes the length of the protection period, if necessary, in step S1504 to step S1507.

(S1504) The setting program 0113 classifies the relationship between the reference period and the protection period into the following three patterns (A) to (C) and proceeds to step S1505 to step S1507 depending on the following patterns:
(A) the reference period is within the protection period (proceed to step S1505);
(B) the reference period partly overlaps with the protection period (proceed to step S1506); and
(C) the reference period does not overlap with the protection period (proceed to step S1507)
(S1505) The setting program 0113 shortens the protection period for the detailed data relating to the relevant event. The protection period may be shortened by reducing certain minutes from the current set value or setting a protection period which covers 90% (the number is arbitrary) of all the events.
(S1506) The setting program 0113 extends the protection period for the detailed data relating to the relevant event. The protection period may be extended by adding certain minutes to the current set value or setting a protection period which covers 90% (the number is arbitrary) of all the events.
(S1507) The setting program 0113 determines that an event corresponding to the protection period, whose time is most close to the reference period, as an event related to the relevant reference period. The setting program 0113 extends the protection period for the detailed data relating to the relevant event. The extension method may be the same as the method described in step S1506.

The period of time during which the administrator will refer to the detailed data at a later date varies depending on the administrator (or more than one administrator) or an information processing system which is a target to be monitored. For example, an administrator of information processing system A refers to detailed data for a period of time before and after the occurrence of warning event 1, while an administrator of information processing system B does not refer to the period of time before and after the warning event 1. In this embodiment, the management computer 0100 analyzes characteristics of how the administrator referred to the detailed data based on the history of reference to the performance information by the administrator and decides a period of time, for which the detailed data should be kept, in accordance with the characteristics.

### REFERENCE SIGNS LIST

0100 management computer; 0101 CPU; 0102 storage resource; 0103 output I/F; 0104 input I/F; 0105 storage device I/F; 0106 display; 0107 storage device; 0108 NIC; 0110 monitoring program; 0111 summary program; 0112 detailed data deletion program; 0113 setting program; 0114 reference management program; 0115 quota setting program; 0200 detailed data table; 0300 summary data table; 0400 event table; 0500 setting table; 0600 protection period table; 0700 baseline table; 0800 data reference recording table; 0900 quota table; 0130 monitoring target computer; 0131 CPU; 0132 storage resource; 0133 NIC; 0134 storage device I/F; 0138 storage device; and 0150 network.

1. A monitoring computer for monitoring a monitoring target computer,
the monitoring computer comprising:
a storage device for storing measurement data about the monitoring target computer at a plurality of points in time;
a CPU for displaying the measurement data on a display device; and
a storage resource for storing data used by the CPU, wherein the CPU:
specifies an event, which has occurred at the monitoring target computer, and event occurrence time based on the measurement data;
selects part of the measurement data at the plurality of points in time as a deletion target in consideration of the measurement data which should not be deleted based on
(1) a capacity of the storage device or a predetermined retention period of the measurement data and
(2) a deletion exception period calculated from the event occurrence time; and
deletes the selected measurement data from the storage device.

2. The monitoring computer according to claim 1, wherein the measurement data at the plurality of points in time includes measurement data of a first type that is used to specify the event, and measurement data of a second type which is different from the first type; and
wherein the measurement data which should not be deleted includes the measurement data of the first type and the measurement data of the second type.

3. The monitoring computer according to claim 2, wherein the deletion exception period is found by:
(2a) specifying a type of the event;
(2b) specifying an adjacent time period of the measurement data which should not be excluded from time of a base point, based on the event type; and
(2c) calculating the deletion exception period from the adjacent time period by setting the event occurrence time as the base point.

4. The monitoring computer according to claim 3, wherein the CPU:
manages deletion exception priority according to the event type; and
selects the measurement data, which should not be deleted, based on the deletion exception priority.

5. The monitoring computer according to claim 4, wherein the CPU:
records whether the measurement data included in the exception period has become a display target or not, in the storage resource in accordance with display of the measurement data; and
sets the measurement data which should not be deleted and was not the display target in the past, as a deletion target.

6. The monitoring computer according to claim 5, wherein the CPU:
stores baseline data, which is created by statistic processing of the measurement data and indicates a time transition of normal measurement data, in the storage resource; and
specifies the event by comparing the baseline data with the measurement data.

7. The monitoring computer according to claim 6, wherein the storage resource or the storage device stores summary data corresponding to the deletion target data; and
wherein the CPU displays the summary data in combination with the measurement data.

8. A monitoring method for a monitoring computer for monitoring a monitoring target computer,
the monitoring computer including:
a storage device for storing measurement data about the monitoring target computer at a plurality of points in time;
a CPU for displaying the measurement data on a display device; and
a storage resource for storing data used by the CPU, the monitoring method comprising:
a first step executed by the CPU specifying an event, which has occurred at the monitoring target computer, and event occurrence time based on the measurement data;
a second step executed by the CPU selecting part of the measurement data at the plurality of points in time as a deletion target in consideration of the measurement data which should not be deleted based on a capacity of the storage device or a predetermined retention period of the measurement data and a deletion exception period calculated from the event occurrence time; and
a third step executed by the CPU deleting the selected measurement data from the storage device.

9. The monitoring method according to claim 8, wherein the measurement data at the plurality of points in time includes measurement data of a first type that is used to specify the event, and measurement data of a second type which is different from the first type; and
wherein the measurement data which should not be deleted includes the measurement data of the first type and the measurement data of the second type.

10. The monitoring method according to claim 9, wherein the deletion exception period is found by:
(2a) specifying a type of the event;
(2b) specifying an adjacent time period of the measurement data which should not be excluded from time of a base point, based on the event type; and
(2c) calculating the deletion exception period from the adjacent time period by setting the event occurrence time as the base point.

11. The monitoring method according to claim 10, wherein in the second step, the CPU:
manages deletion exception priority according to the event type; and
selects the measurement data, which should not be deleted, based on the deletion exception priority.

12. The monitoring method according to claim 11, wherein in the second step, the CPU:
records whether the measurement data included in the exception period has become a display target or not, in the storage resource in accordance with display of the measurement data; and
sets the measurement data which should not be deleted and was not the display target in the past, as a deletion target.

13. The monitoring method according to claim 12, wherein in the first step, the CPU:
stores baseline data, which is created by statistic processing of the measurement data and indicates a time transition of normal measurement data, in the storage resource; and
specifies the event by comparing the baseline data with the measurement data.

14. The monitoring method according to claim 13, wherein the storage resource or the storage device stores summary data corresponding to the deletion target data; and
wherein the CPU displays the summary data in combination with the measurement data.
